(19) United States
(12) Patent Application Publication
(10) Pub. No.: US 2013/0302133 A1
(43) Pub. Date: Nov. 14, 2013

(54) LIFTING DEVICE

(71) Applicants: Adam DAVIS, Leola, PA (US); Steven MICHELMAN, Las Vegas, NV (US); Scott FISHER, Las Vegas, NV (US)

(72) Inventors: Adam DAVIS, Leola, PA (US); Steven MICHELMAN, Las Vegas, NV (US); Scott FISHER, Las Vegas, NV (US)

(73) Assignee: FTSI, LLC, Las Vegas, NV (US)

(21) Appl. No.: 13/470,892

(22) Filed: May 14, 2012

(51) Int. Cl. B66F 9/00

(52) U.S. Cl. 414/815; 414/680

(57) ABSTRACT

A lifting device includes a housing movably securable to a support structure extending along a predetermined path corresponding to a portion of the support structure. The housing includes a motorized lifting machine movable with the housing. The housing includes an engagement device movable with the housing, the engagement device operably engaging the portion of the support structure to move the housing.

### FIELD

The disclosure is generally related to a motorized lifting device for positioning a load. More particularly, the disclosure includes a movable motorized lifting device for manipulating staging equipment.

### BACKGROUND

When presenting events such as concerts or theatre productions, winches, pulleys and other equipment are commonly used for support, movement and manipulation of performers and various equipment, such as, lighting, sound, scenery and props. This equipment, such as a first or primary winch, is movably secured to support structure. In order to move the primary winch along the support structure from a first position toward a second position, a cable from a second winch that is connected to the primary winch is retracted. However, in order to return the primary winch to a previous position along the support structure, such as from the second position toward the first position, a cable from a third winch that is connected to the primary winch must be refracted, while simultaneously reversing the operation of the second winch, i.e., extending or “playing out” cable from the second winch. The associated pair of additional winches and corresponding cable increase the cost and complexity of the production. There currently remains a need in the staging industry to provide a lifting device having fewer components.

What is needed is a method and apparatus or device that addresses the above-referenced issues and concerns. The present device addresses the issues listed above.

### SUMMARY

An aspect of embodiments of the present disclosure includes a system that provides a lifting device for manipulating loads associated with public performances, such as performers and staging equipment.

In an exemplary embodiment, a lifting device including a housing movably securable to a support structure extending along a predetermined path corresponding to a portion of the support structure. The housing includes a motorized lifting machine movable with the housing. An engagement device is movable with the housing, the engagement device operably engaging the portion of the support structure to move the housing.

In a further exemplary embodiment, a method of supporting a load includes providing a lifting device including a housing movably securable to a support structure extending along a predetermined path corresponding to a portion of the support structure. The housing includes a motorized lifting machine movable with the housing. An engagement device is movable with the housing. The method further includes controllably moving the housing along the path with the engagement device.

Another aspect includes providing a lifting device configured to be movably securable to a portion of a support structure that can be maintained at a generally constant spacing or a variable spacing with respect to a predetermined path.

Still another aspect is to provide a lifting device configured to be movably securable to a portion of a support structure that may be substantially rigid, flexible, or a combination thereof.

Yet another aspect is to provide lifting device configured to be movably securable to a portion of a support structure that may be a cable suspended from the support structure.

Another aspect is to provide a lifting device usable with support structure segments that may be positioned interchangeably (i.e., reversible).

It is to be understood that an embodiment of a lifting device may include one or more of the above-described aspects.

Further aspects of the method and system are disclosed herein. The features as discussed above, as well as other features and advantages of the present disclosure will be appreciated and understood by those skilled in the art from the following detailed description and drawings.

### BRIEF DESCRIPTION OF THE DRAWINGS

FIG. 1 shows a perspective view of a lifting device according to an exemplary embodiment of the disclosure.

FIG. 2 shows an end view of the lifting device of FIG. 1 according to an exemplary embodiment of the disclosure.

FIG. 3 shows a top view of the lifting device of FIG. 1 according to an exemplary embodiment of the disclosure.

FIGS. 4 and 4A show embodiments of roller assemblies of the lifting device of FIG. 1 according to an exemplary embodiment of the disclosure.

FIG. 5 shows a plan view of an embodiment of an engagement device taken along region 5 of FIG. 3, according to an exemplary embodiment of the disclosure.

FIG. 6 shows a plan view of a further alternate embodiment of an engagement device taken along region 5 of FIG. 3, according to an exemplary embodiment of the disclosure.

FIG. 7 shows a side view of the lifting device supporting a load according to an exemplary embodiment of the disclosure.

FIG. 8 shows an end view of the lifting device of FIG. 7 according to an exemplary embodiment of the disclosure.

FIG. 9 shows an enlarged view of the lifting device movably secured by support structure taken along region 9 of FIG. 4 according to an exemplary embodiment of the disclosure.

FIG. 10 shows an enlarged view of the lifting device movably secured by support structure taken along region 9 of FIG. 4 according to an exemplary embodiment of the disclosure.

FIG. 11 shows a perspective view of a lifting device movably supported by support structure according to an exemplary embodiment of the disclosure.

FIG. 12 shows a perspective view of lifting device of FIG. 7 according to an exemplary embodiment of the disclosure.

FIG. 13 shows a schematic view of lifting device according to an exemplary embodiment of the disclosure.

### DETAILED DESCRIPTION

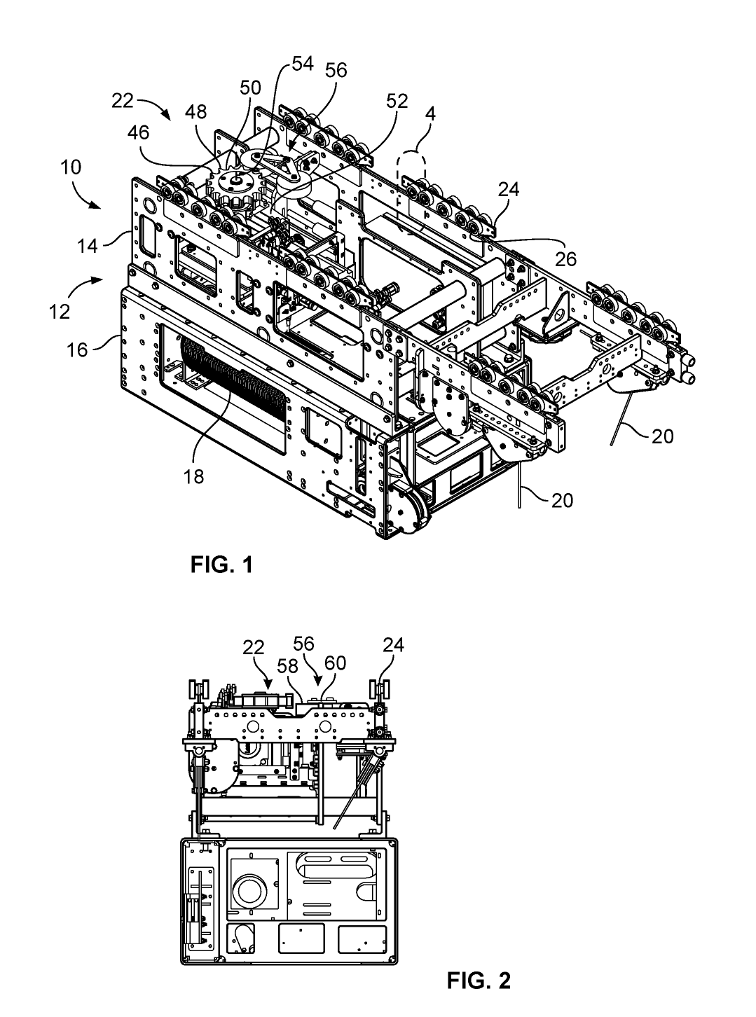

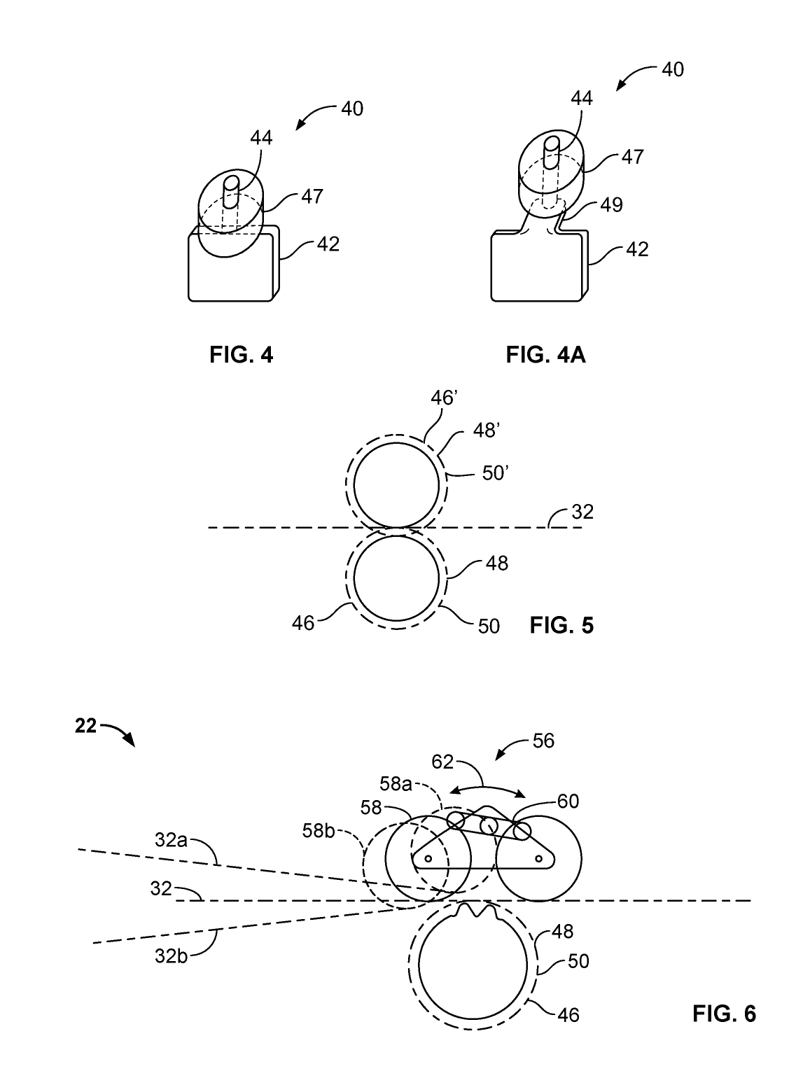

FIG. 1 shows a perspective view of a lifting device 10 according to an embodiment of the disclosure. The lifting device 10 includes a housing 12 having a first portion 14 secured to a second portion 16. As further shown in FIG. 1, first portion 14 includes roller assemblies 24 that are movably securable to a support structure 30 (see e.g., FIG. 7). In an alternate embodiment, such as shown in FIG. 4, a roller assembly 40 includes a structural portion 42 that extends to an axle 44 that rotatably secures a roller 47 at an angle with respect to corresponding rollers of roller assembly 24. In a further alternate embodiment as shown in FIG. 4A, structural portion 42 further includes an offset 49, permitting a pair of opposed roller assemblies 40 to be used to extend in opposite directions, if desired. In one embodiment, axle 44 of roller assembly 40 is positioned transverse of roller axles 26 of roller assembly 24. In a further embodiment, a roller assembly incorporating differently arranged rollers, such as from roller assembly 24 and roller assembly 40 may be combined in a single roller assembly, if desired. Second portion 16 includes a rotatably movable lifting machine 18, such as a motorized drum configured to extend/retract cable 20 with respect to housing 12 to manipulate loads, such as actors or props for theatrical performances/events and the like. In one embodiment, the drum of lifting machine 18 extends from housing 12 at a zero fleet angle. In another embodiment, lifting machine 18 includes a chain drive. An engagement device 22 is operatively connected to housing 12. Engagement device 22 is configured to controllably move housing 12 along a predetermined path of support structure as discussed in further detail below.

For purposes of the disclosure, the terms operably engage and operatively connect and variations thereof may be used interchangeably.

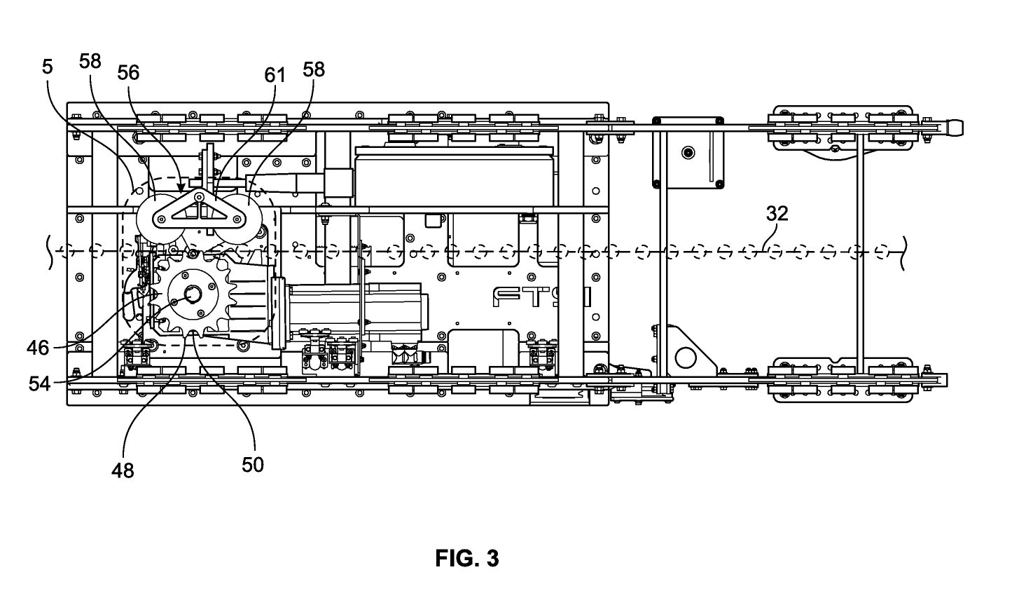

As shown FIGS. 2-3, engagement device 22 includes a driving component 46, such as a drive gear, having a plurality of uniformly spaced teeth 48 separated by uniformly spaced recesses 50. Driving component 46 is driven by a source of rotational movement such as a motor 52 such that driving component 46 rotates about an axis 54. Driving component 46 may include a retention portion 56 that is positioned in close proximity with driving component 46 such that a portion 32 of support structure 30, such as a chain, continuously meshes with driving component 46 by virtue of retention portion 56, such that rotational movement of driving component 46 results in the movement of housing 12 with respect to the support structure. In another embodiment, the portion of support structure may be affixed to the support structure and may be rigid, having a substantially fixed spacing from the predetermined path of the support structure. As further shown in FIG. 3, retention portion 56 includes a pair of retention members 58 maintained in close proximity with each other by a frame 61. As shown in FIG. 3, driving component 46 and retention members 58 of retention portion 56 are sized and arranged to permit continuous engagement or meshing with portion 32 of the support structure. In an alternate embodiment of engagement device 22 as shown in FIG. 5, driving component 46 is configured to synchronously rotate with respect to a second driving component 46′ such that corresponding teeth 48, 48′ and recesses 50, 50′ remain rotationally aligned with each other to receive and provide continuous engagement or meshing with portion 32 of the support structure. In yet a further embodiment, in place of driving component 46′, such as an appropriately sized wheel of a resilient material 51′ may be used to maintain the continuous engagement or meshing between driving component 46 and portion 32 of the support structure.

It is to be understood that engagement device 22 and retention portion 56 may be configured such that portion 32 of the support structure may be rigid, or flexible. For example, in an embodiment in which portion 32 is a chain, it may be possible that portion 32 may be rigid, if each link of the chain is affixed to a rigid support structure 30, such as a truss structure as shown in FIG. 7. However, if a number of links of the chain are not affixed to support structure 30, the chain is at least partially movable with respect to the support structure. Stated another way, although retention portion 56 may be rigid or flexible with respect to support structure 30 (and therefore, similarly rigid or flexible with respect to engagement device 22 and retention portion 56), engagement device 22 and retention portion 56 may be configured such that housing 12 (FIG. 1) is operably connected to the support structure such that the engagement device controllably moves the housing along a predetermined path as defined by the support structure, the portion 32 of the support structure generally extending along the predetermined path. That is, even when the portion 32 of the support structure may deviate from a fixed spacing from the support structure 30 at one or more positions along the support structure, as the housing 12 approaches a position of the support structure, the corresponding portion 32 of the support structure will become engaged or mesh or otherwise be operatively connected to engagement device 22.

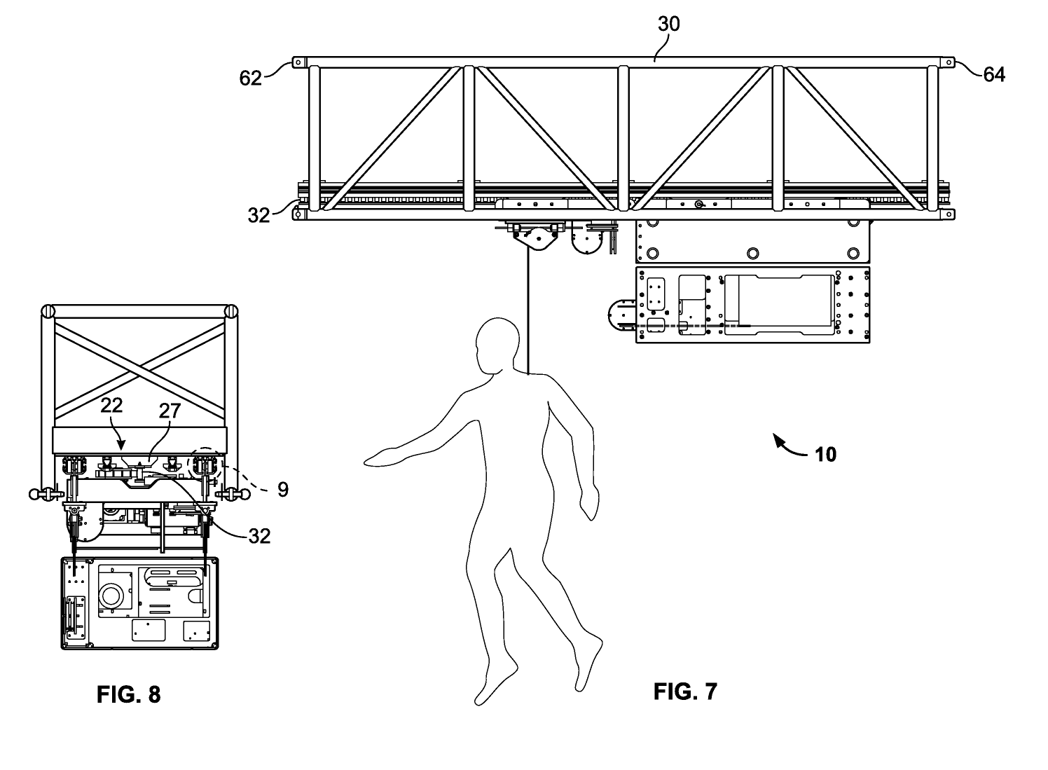

As shown in FIG. 6, retention portion 56 may be movable along a slot 60 formed in housing 12 (FIG. 1) in a manner permitting continuous engagement or meshing with portion 32 of the support structure even when alignment of portion 32 of the support structure deviates from a predetermined path with respect to engagement device 22 and support structure (FIG. 1). For example, when portion 32 is substantially parallel to opposed roller assemblies 24 of housing 12 (FIG. 1), the path traced by the portion prior to establishing an operative connection between retention portion 56 and driving component 46 is identified as portion 32 and establishing a tangential operative connection or contact with teeth 48 and recesses 50 of retention member 58 of retention portion 56 and driving component 46. However, if the path of the portion were to deviate from the path identified as portion 32 to the path identified as portion 32a, movement 62 of retention portion 56 along slot 60 can occur to help align and more easily provide a continuous tangential operative connection between or contact with retention member 58a of retention portion 56 and teeth 48 and recesses 50 of driving component 46. Similarly, if the path of the portion were to deviate from the path identified as portion 32 to the path identified as portion 32b, movement 62 of retention portion 56 along slot 60 can occur to help align and more easily provide a continuous tangential operative connection between or contact with retention member 58b of retention portion 56 and teeth 48 and recesses 50 of driving component 46.

FIGS. 7-8 show housing 12 of lifting device 10 being movably securable to support structure 30 extending along a predetermined path. As further shown, portion 32 of support structure 30 is a chain supported along the support structure by a plurality of bracket assemblies 27, to permit a continuous operative connection with engagement device 22. As shown, bracket assemblies 27 secure portion 32 in a substantially centered position beneath the support structure. As discussed above for other embodiments, portion 32 may be rigid or flexible and may also be used with support structure that includes nonlinear segments in which both portion 32 and the support structure may be nonlinear.

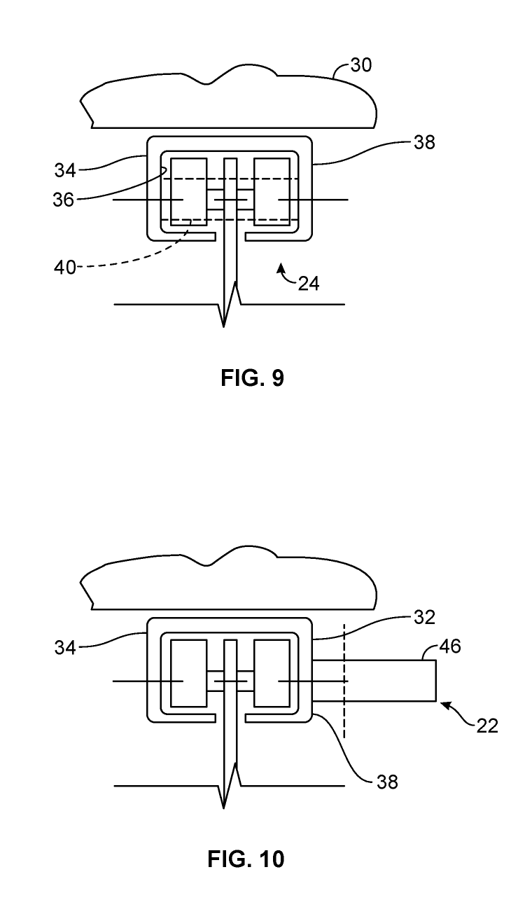

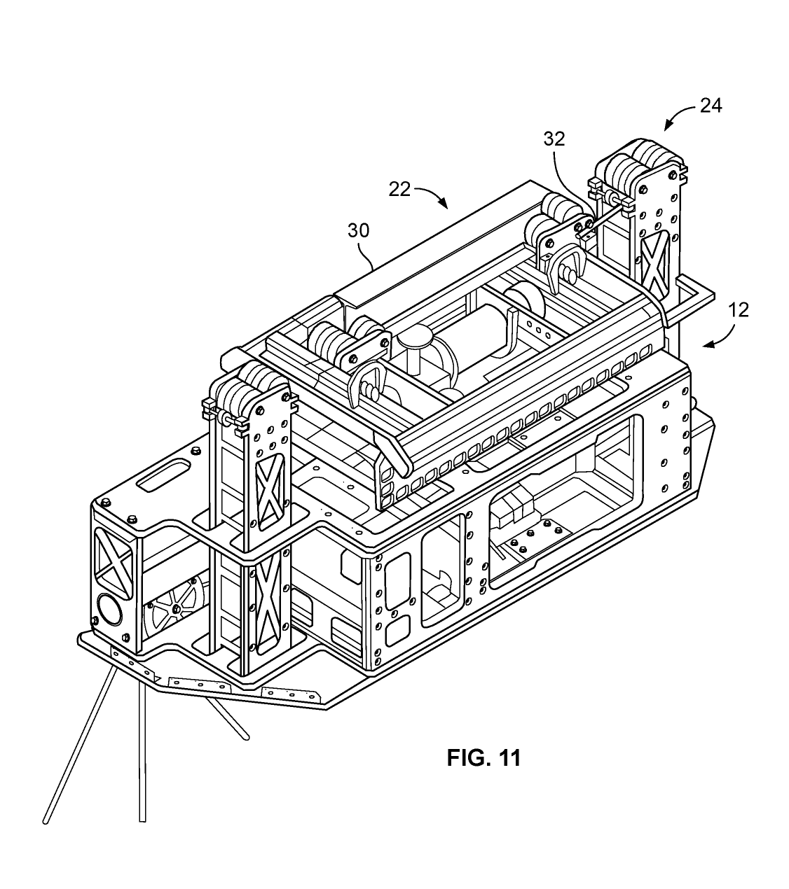

FIG. 9 shows an enlargement of region 9 taken from FIG. 8, in which support structure 30 further includes a substantially enclosed passageway or structure 34, resembling a C-section structural member with the opening facing downward in order to receive roller assembly 24. In alternate embodiments, structure 34 may be an open structure such as an I-beam (FIG. 11) or other structure, if desired. As shown, structure 34 includes inner surfaces 36 that are configured to movably receive rollers of roller assembly 24, including alternate embodiments of roller assembly 40. Roller assembly 40 may be utilized to reduce friction associated with nonlinear segments of the support structure.

FIG. 10 shows an alternate embodiment of region 9 taken from FIG. 8, in which structure 34 includes features formed in at least one outer surface 38 of structure 34 such that continuous operative connection may be maintained between a portion of the support structure and engagement device 22. For example, features formed in outer surface 38 of structure 34 may include uniformly spaced grooves or protrusions, resembling a rack and pinion arrangement.

FIG. 11 shows an alternate embodiment of the lifting device that is configured to receive a single support structure 30, such as an I-beam, having a portion 32 such as a cable suspended beneath the I-beam for use with positioning the lifting device with respect to the support structure. Engagement device 22 may be configured to include a drum (not shown) similar to that previously discussed, except in this instance, a sufficient amount of cable would be installed on the drum to provide controllable movement of the housing along the I-beam, depending upon the direction of rotation of the drum.

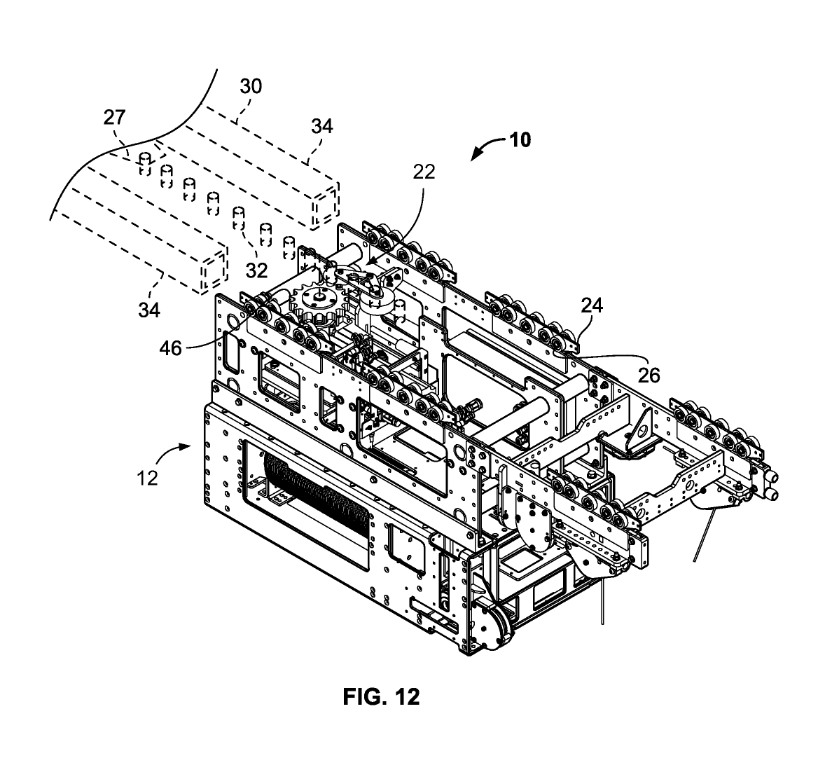

FIG. 12, which is an embodiment of FIGS. 7-9 shows housing 12 of lifting device 10 being movably securable to support structure 30 extending along a predetermined path. As further shown, portion 32 of support structure 30 is a uniformly spaced set of links, such as pegs supported along the support structure by a plurality of bracket assemblies 27, to permit a continuous operative connection with engagement device 22. As further shown in FIG. 12, bracket assemblies 27 secure portion 32 in a substantially centered position beneath the support structure. Such a construction permits support structure to be installed such that ends 62, 64 (FIG. 7) of support structure 30 may be positioned interchangeably, i.e., the support structure is reversible. That is, due to portion 32 being substantially centered with respect to substantially enclosed passageways or structures 34 of support structure 30, ends 62, 64 of support structure 30 may be installed with the ends facing either direction, thereby simplifying construction of the support structure, unlike conventional structure, especially when a section support structure includes a curved or nonlinear portion.

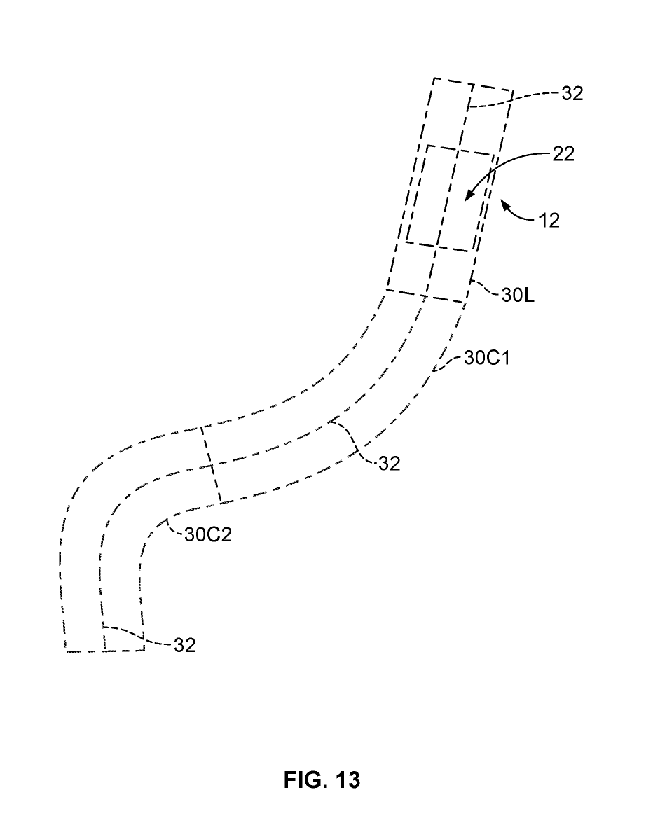

For example, as shown in FIG. 13, support structure 30 may include three segments or sections, such as a linear segment 30L, a first curved segment 30C1 and a second curved segment 30C2. Since portion 32 extends substantially centered through each of the segments, the ends of each segment or section may be reversed without affecting operation of housing 12, i.e., permitting engagement device 22 to be continuously operatively connected to portion 32 of the support structure, as discussed above. That is, as discussed above for other embodiments, portion 32 may be rigidly or flexibly secured to support structure 30, and may also be used with support structure that includes nonlinear segments in which both portion 32 and the support structure may be nonlinear. It is to be understood that segments of support structure 30, including portions 32 that may be rigidly or flexibly secured to support structure 30, and may also be used with support structure that includes nonlinear segments in which both the portion and the support structure may be nonlinear, may also be positioned interchangeably, i.e., the segments of the support structure are reversible.

It is important to note that the construction and arrangement of the present application as shown in the various exemplary embodiments is illustrative only. Only certain features and embodiments of the invention have been shown and described in the application and many modifications and changes may occur to those skilled in the art (e.g., variations in sizes, dimensions, structures, shapes and proportions of the various elements, values of parameters (e.g., temperatures, pressures, etc.), mounting arrangements, use of materials, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A lifting device comprising:
a housing movably securable to a portable support structure having reversible segments with opposed portions thereon, the support structure extending along a predetermined path, the housing comprising:
a motorized lifting machine movable with the housing; and
an engagement device movable with the housing, the engagement device operably engaging one of the opposed portions of the support structure to move the housing.

2. The lifting device of claim 1, wherein the portion of the support structure extends along a fixed, predetermined path.

3. The lifting device of claim 1, wherein segments of the support structure are interchangeably positionable.

4. The lifting device of claim 3, wherein the engagement device is continuously operatively connected to the portion of the support structure generally extending along the predetermined path.

5. The lifting device of claim 4, wherein the portion of the support structure operatively connected to the engagement device extends at a generally constant spacing from the predetermined path.

6. The lifting device of claim 4, wherein the portion of the support structure operatively connected to the engagement device extends at a variable spacing from the predetermined path.

7. The lifting device of claim 4, wherein the portion of the support structure operatively connected to the engagement device is a flexible member.

8. The lifting device of claim 4, wherein the engagement device includes a driving component configured to operatively connect with the portion of the support structure.

9. The lifting device of claim 8, wherein the engagement device includes a retention portion positioned in close proximity to the driving component, the portion of the support structure positioned between and operatively connected to the retention portion and the driving component.

10. The lifting device of claim 9, wherein the retention portion includes at least one retention member.

11. The lifting device of claim 10, wherein the retention portion includes a pair of retention members rotatably connected in close proximity to each other by a frame.

12. The lifting device of claim 1, wherein the motorized lifting machine includes a drum configured to extend/retract cable with respect to the housing at a zero fleet angle.

13. The lifting device of claim 1, wherein the motorized lifting machine is a chain drive.

14. A method of supporting a load comprising:
providing a lifting device comprising:
a portable housing movably securable to a support structure having reversible segments with opposed portions thereon, the support structure extending along a predetermined path, the housing comprising:
a motorized lifting machine movable with the housing; and
an engagement device movable with the housing by operatively engaging one of the opposed portions; and
controllably moving the housing along the path with the engagement device.

15. The method of claim 14, wherein the engagement device is continuously operatively connected to the portion of the support structure generally extending along the predetermined path.

16. The method of claim 15, wherein segments of the support structure are interchangeably positionable.

17. The method of claim 14, wherein the portion of the support structure operatively connected to the engagement device extends at a variable spacing from the predetermined path.

18. The method of claim 14, wherein the portion of the support structure operatively connected to the engagement device is a flexible member.

19. The method of claim 14, wherein the engagement device includes a driving component configured to operatively connect with the portion of the support structure.

20. The method of claim 19, wherein the engagement device includes a retention portion positioned in close proximity to the driving component, the portion of the support structure positioned between and operatively connected with the retention portion and the driving component.
